(19) United States
(12) Patent Application Publication
(10) Pub. No.: US 2004/0034467 A1
(43) Pub. Date: Feb. 19, 2004

(54) System and method for determining and employing road network traffic status

(76) Inventors: Paul Sampedro, San Diego, CA (US); David Brandos, San Diego, CA (US); Philip White, San Diego, CA (US)

Correspondence Address: Qualcomm Incorporated, Patents Department, 5775 Morehouse Drive, San Diego, CA, 92121-1714, US

(21) Appl. No.: 10/215,712

(22) Filed: Aug. 9, 2002

(51) Int. Cl. G01C 21/26

(52) U.S. Cl. 701/201

(57) ABSTRACT

A system and method for maintaining a road network traffic status database comprised of map segments with the network where vehicles' locations and speeds with the network are wireless received and used to update an average speed of the map segments and where an optimal route between a first and second location is determined from the database.

### BACKGROUND OF THE INVENTION

I. Field of the Invention

The invention relates to methods and apparatus for developing and maintaining a road network traffic status database and employing the database to optimize vehicle navigation on the road network, in particular, on a real time basis.

II. Description of the Related Art

Fixed position speed monitoring devices exist. These devices are commonly imbedded in a road surface and determine the speed of some vehicles passing over the device. These devices are expensive to install and thus their number on the US road network limited. In addition, when vehicular traffic is completely stopped over a device no data is provided. This information gap may be critical where the vehicular traffic is halted due an accident or other event that has traffic on the road in which the device is embedded halted. Thus, a need exists other means of determining road network traffic status and employing the status to optimize vehicle navigation on the road network.

### SUMMARY OF THE INVENTION

The invention includes a system and method of determining optimal routes on a road network. The system receives data communications from a wireless network where the data communications include vehicle positions and speeds from a plurality of units within vehicles traveling on the road network. The system also receives a request for an optimal route between a first location and a second location from a requesting unit and determines an optimal route between the first location and the second location based on the received vehicle positions and speeds. The system transmits the optimal route to the requesting unit.

The system may also store the received vehicle positions and speeds and may further correlate a plurality of vehicle positions and speeds to determine an average speed. In this system, the optimal route between the first location and second location may be determined from the correlated vehicle speeds. The system may also store the vehicle positions and speeds along the time and date they are received in a memory.

In another embodiment, the system determine an average vehicle speed within a segment of the road network by determining which received vehicle positions and speed data are within the segment and averaging only those speeds. Also, the system may determine an average vehicle speed within a segment of the road network by determining which received vehicle positions and speed data are within the segment and have been received with a predefined time limit and averaging only those speeds.

The unit requesting the optimal route may also be coupled to the wireless network and further located within a vehicle on the road network. In addition, the requesting unit may periodically transmit its vehicle's position and speed.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is an illustration of road network traffic status architecture;

FIG. 2 illustrates a terrestrial mobile communications terminal (“TMCT”) in functional block diagram format that may be employed as both a roving location determination device and mobile navigation system in FIG. 1;

FIG. 3 illustrates a network management center (“NMC”) system of the present invention in functional block diagram format that may be employed in the architecture shown in FIG. 1;

FIG. 4 illustrates a flow diagram representing a method for updating a map segment database based on received roving device data;

FIG. 5 illustrates a flow diagram representing a method for updating a map segment database based on received weather based data;

FIG. 6 illustrates a flow diagram representing a method for updating a map segment database based on received location based projected road network construction data;

FIG. 7 illustrates a flow diagram representing a method for updating a map segment database based on received location based actual road network construction data;

FIG. 8 illustrates a flow diagram representing a method for updating a map segment database based on received location based road network traffic accident data;

FIG. 9 illustrates a flow diagram representing a method for updating a map segment database based on received fixed location traffic data;

FIG. 10 illustrates a flow diagram representing a method for determining an optimal road network route based on a starting location and proposed destination on the network and the map segment database;

FIG. 11 illustrates a flow diagram representing a method for determining an optimal order and road network routes based on a starting location and several proposed destinations in the network and the map segment database;

FIG. 12 illustrates a flow diagram representing a method for requesting and receiving an optimal road network route based on a desired destination and current location;

FIG. 13 illustrates a flow diagram representing a method for requesting and receiving an optimal order and road network routes based on several desired destinations and current location;

FIG. 14 illustrates a flow diagram representing a method for determining optimal route between location and desired location based on map segments;

FIG. 15 illustrates a flow diagram representing a method for determining whether a segment is valid; and

FIG. 16 illustrates different possible map segments on a partial road network map.

### DETAILED DESCRIPTION OF THE PREFERRED EMBODIMENTS

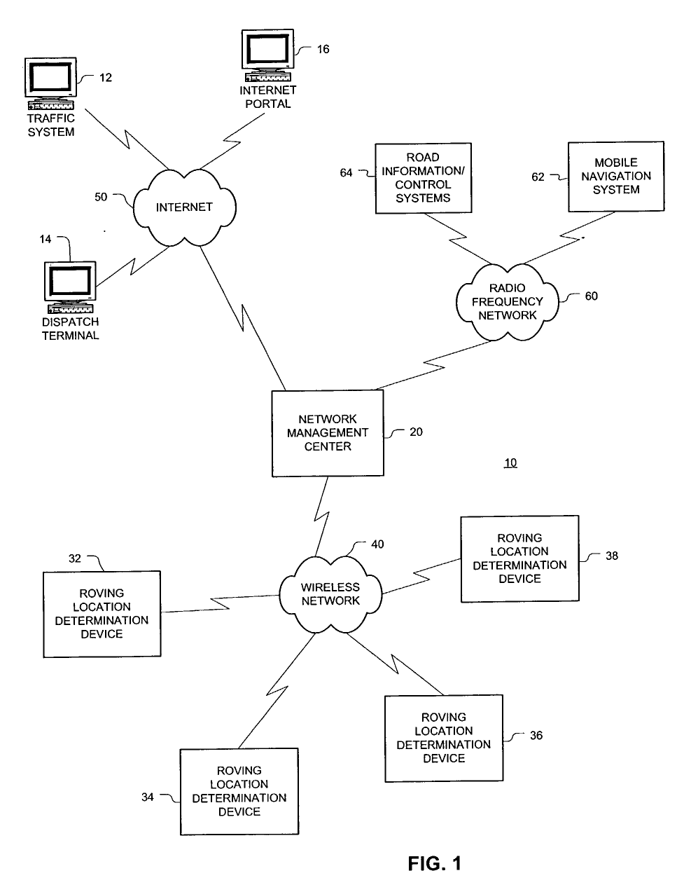

FIG. 1 is a block diagram of an exemplary road network traffic status architecture 10 in which various embodiments of the present invention may be employed. The architecture 10 includes a network management center (“NMC”) system 20 coupled to a plurality of roving location determination devices 32, 34, 36, and 38 via a wireless network 40. The NMC 20 may also be coupled to mobile navigation systems 62 and road information or control systems 64 via a radio frequency network 60. In one exemplary embodiment, the mobile navigation systems 62 may also be roving location determination devices. Further, in one embodiment described below for illustrative purposes, a roving location determination device 32 is part of a terrestrial mobile communications terminal (“TMCT”). The TMCT is mounted in a vehicle or part of a mobile device optimally geographically located within the operational boundaries of the wireless network 40 and within the road network. The TMCT 32 may include a mobile navigation system 62 in this illustrative embodiment.

The NMC 20 may also be coupled to one or more traffic systems 12, dispatch stations 14, and internet portals 16. The NMC 20 may be coupled to the traffic system 12 and dispatch stations 14 by dialup connection, Internet connection, or direct connection (local area network). The NMC 20 may be coupled to the wireless network 40 and radio frequency network 60 via plain old telephone service (POTS) at a POTS entry point to the wireless network or wirelessly to the network 40. In one exemplary embodiment, the wireless network 40 may be part of the radio frequency network 60. The road network traffic status architecture 10 is used to determine road network traffic status. The NMC 20 may also employ the status to optimize vehicle navigation on the road network where a mobile navigation system 62, dispatcher (via a dispatch terminal 14), internet portal user 16, or TMCT 32 requests an optimal route from a location for one or more desired destinations. The NMC 20 may also employ the status to provide general traffic conditions, suggested road expansions, and other traffic data. Further, the NMC 20 may employ the status to control road information messages (“RIS”) (electronic roadside signs) and on-ramp metering systems of the road network.

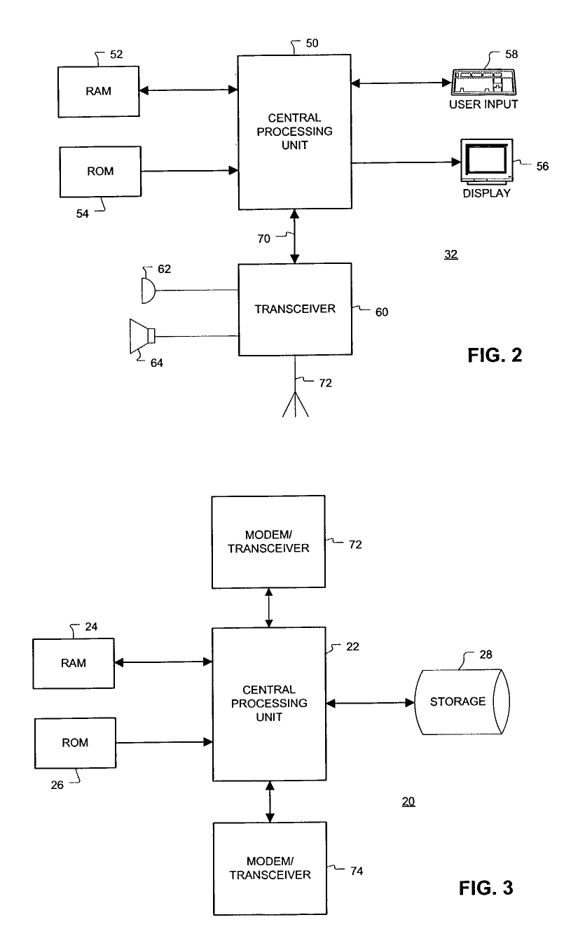

A block diagram of TMCT 32 is shown in FIG. 2. The TMCT 32 includes a central processing unit (“CPU”) 50, a random access memory (“RAM”), a read only memory (“ROM”), a display 56, a user input device 58, a transceiver 60, a microphone 62, a speaker 64, and an antenna 72. The ROM 54 is coupled to the CPU 50 and stores the program instructions to be executed by the CPU 50. The RAM 52 is also coupled to the CPU 50 and stores temporary program data. The ROM 54 and RAM 52 may also be used to store map data for the road network. The user-input device 58 may include a keypad, a touch pad screen, a track ball, or other input device. The user employs the input device 58 to navigate through menus, to generate messages, request route information, and other functions. The display 56 is an output device such as a CRT, a LCD, or other user perceptible device. The user may employ the display 56 to read decoded messages or other data transmitted from a dispatch station 12 or 14 or other unit (TMCT 32) via the wireless network 40. The CPU 50 may be an Intel™ 80186 processor in one embodiment.

The microphone 62 and speaker 64 may be incorporated in a handset coupled to the transceiver 60. The microphone 62 and speaker 64 may also be more physically separated to enable hands free communication with the user of the TMCT 32. In this mode, the transceiver 60 may include voice activation circuitry that may convert voice into data transmitted to the CPU 50 for processing. The data is transmitted to CPU 50 via a serial bus 70.

The transceiver 60 includes the instruction set necessary to communicate data and voice signals over the network 40. In one embodiment, the transceiver 60 supports code division multiple access (“CDMA”) protocols and the wireless network is a CDMA based network that supports data and voice signals. The transceiver 60 is coupled to the antenna 72 for communicating signals with the wireless network 40. When a data signal is received by the transceiver 60, the data is transferred to the CPU 50 via the serial bus 70. The data may include traffic updates, suggested changes to road navigation, destination, multiple destination order priority, weather, accident, construction or other road network status data. The data may also include software updates for the unit. The transceiver 60 may be capable of receiving position and velocity vector signals to generate a coordinate representation of the TMCT's location within the road network and a velocity vector or the data may be transmitted to the NMC 20 for decoding.

A block diagram of NMC 20 is shown in FIG. 3. The NMC 20 includes a CPU 22, a RAM 24, a ROM 26, a storage unit 28, a first modem/transceiver 72, and a second modem/transceiver 74. The first modem/transceiver 72 may couple the NMC 20 to internet 50. The modem/transceiver 72 may be an Ethernet modem connecting the NMC to a local network or Internet. The second modem/transceiver 74 couples the NMC 20 to the wireless network 40 and radio frequency (“RF”) network 60. The modem/transceiver 74 may again be an Ethernet modem, telephone modem, wireless modem or other communication device that may communicate with the wireless network 40 and RF network 60. In another embodiment, the NMC 20 may include a third modem/transceiver (not shown) for communicating separately with one of the wireless network 40 and RF network 60. The CPU 22 may direct communications between the first and second modem 72 and 74 for messages between the dispatch terminals 14 and one or more TMCT 32, 34, 36 and 38. The CPU 22 also receives telemetry and velocity vector data (coded or decoded) from the wireless network and uses this data to maintain a road network status database. The CPU 22 may receive data indicative of the road network status and use the data to maintain or update the road network database. The CPU 22 may transmit data from the road network status database to the RF network 60 or Internet 50. Further, the CPU 22 may receives requests to analyze the information within the database to provide optimal vehicle navigation through the road network based on a location and one or more desired destinations.

The ROM 26 may store program instructions to be executed by the CPU 22 to perform the above and below described operations. The RAM 24 may be used to store temporary program information, received data, and message. The storage unit 28 may be any unit capable of data storage and may be used to store the road network traffic status database (“RNTSD”). In a preferred embodiment, the NMC 20 maintains a road network traffic status database in storage 28 that includes map segments. Each map segment is a portion of the road network and may overlap another map segment. In addition, a map segment may change size or be absorbed by another map section as the database is maintained. Further, the database ideally stores real time and past data about each map segment where the past data may be sorted based calendar date, day of week, and time of day.

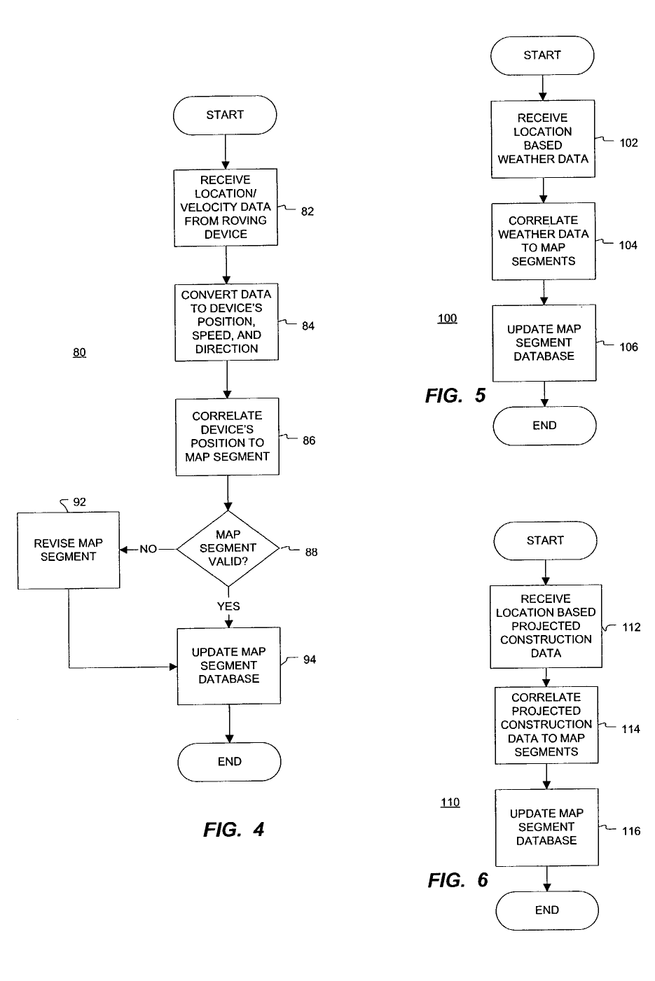

Exemplary algorithms for maintaining the RNTSD, in particular the map segments, are presented with reference to FIGS. 4 to 9, 15, and 16. FIG. 4 illustrates a flow diagram 80 for updating a map segment of the RNTSD based on received roving device data. In this flow diagram 80, the NMC 20 receives location and velocity data from a roving device (step 82). The data may be coded or decoded. The NMC 20 converts the data to a standard format position and velocity vector (comprising speed and direction) and time stamps the data (step 84). In one embodiment, the position is converted to latitude and longitude coordinates and the velocity vector is converted to speed and 360 degree vector where true North is 0 degrees. The NMC 20 searches the RNTSD for a map segment having, or closest to, the converted position. When the map segment does not include the position, the map segment is expanded to include the position. The NMC 20 may determine whether the map segment is valid based on preset criteria (step 88) and revise the segment if necessary (step 92).

A flow diagram 88 for determining whether a map segment is valid is shown in FIG. 15 and discussed with reference to the illustrative partial road network map of FIG. 16. The flow diagram 88 determines the number of independent traffic data sources in a segment. Received position data may also include a unique device identifier so the NMC 20 can distinguish similar data from other devices. The NMC 20 may calculate the age (i.e., in minutes) of the data sources and archive position data that is aged more than a predetermined number of minutes (such as five minutes) in one embodiment (step 212). Then the average speed of the remaining data (within age criteria) is determined (step 214). In a preferred embodiment each map segment have a minimum number of current sources (or position/velocity vector data) to provide a reasonable average (step 218), the minimum number of sources may be six in one embodiment. When the average speed is low (below a predetermined value relative to the maximum allowed speed for the map section e.g., 50% of posted maximum in one embodiment), the average speed may still be considered accurate and thus the map segment still valid for a smaller, low speed minimum number of sources (three in one preferred embodiment) (steps 216 and 222). Otherwise, the NMC 20 may consider the map segment invalid (step 224) or too small. For example, in partial map 230 of FIG. 16, map segment 234 has three current sources and map segment 232 has six current sources (represented by vehicles). Map segment 234 may be invalid and absorbed by Map segment 232 when the average speed of the three vehicles is greater than 50% of the posted speed in this example. Then the map segment 234 may be revised or absorbed into map segment 232 (step 92). The RNTSD is updated accordingly (step 94) of flow diagram 80 where the aged data may be archived for the map segment and the map segment redefined.

The NMC 20 may receive other data indicative of the road network status. FIG. 5 illustrates a flow diagram 100 for updating the RNTSD based on received weather based data. The NMC 20 receives location specific weather data (step 102) where the weather location may an area of the road network, determines the map segments that are within the area (step 104), and updates the map segments to indicate the weather within these segments (step 106). Accordingly, when the NMC 20 receives a request for weather information or a route that include a map segment with current weather data, the NMC 20 includes the weather data in the message to the requesting device (such as a TMCT, mobile navigation system 62, internet portal user 16, dispatcher at dispatch terminal 14, or traffic system 12).

FIG. 6 illustrates a flow diagram 110 for updating RNTSD based on received location-based projected road network construction data. The NMC 20 receives location specific projected construction data (step 112) where the projected construction location may an area of the road network and times and dates that construction is projected to be active. The NMC 20 determines the map segments that are within the area (step 114), and updates the map segments to indicate the project construction data within these segments (step 116). Accordingly, when the NMC 20 receives a request for a route that include a map segment with projected construction data, the NMC 20 may include a message to the requesting device (such as a TMCT, mobile navigation system 62, internet portal user 16, dispatcher at dispatch terminal 14, or traffic system 12) that construction is projected along the route at a certain time. The NMC 20 may also suggest a route that does not include the map segment when the planned/projected travel time through the map section coincides with the projected construction time.

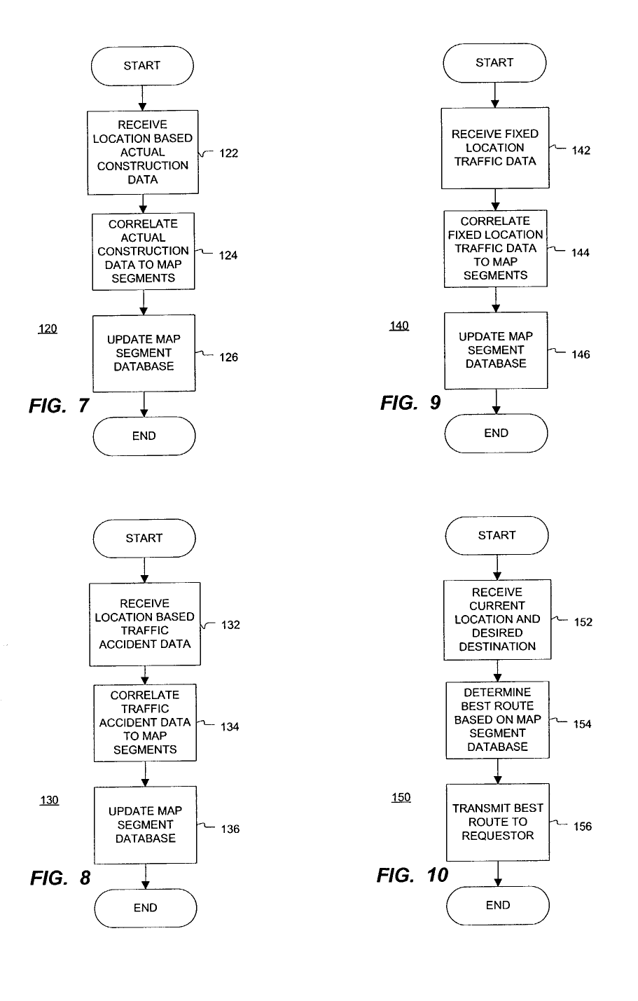

FIG. 7 illustrates a flow diagram 120 for updating RNTSD based on received location based actual/current road network construction data. The NMC 20 receives location-specific actual construction data (step 122) where the actual construction location may an area of the road network. The NMC 20 determines the map segments that are within the area (step 124), and updates the map segments to indicate the construction data within these segments (step 126). Accordingly, when the NMC 20 receives a request for a route that include a map segment with actual construction data, the NMC 20 may includes a message to the requesting device (such as a TMCT, mobile navigation system 62, internet portal user 16, dispatcher at dispatch terminal 14, or traffic system 12) that construction is active along the route. The NMC 20 may also suggest a route that does not include the map segment.

FIG. 8 illustrates a flow diagram 130 for updating the RNTSD based on received location-based road network traffic accident data. The NMC 20 receives the location-based road network traffic accident data (step 132) and determines the map segments that are within the accident area (step 134), and updates the map segments to indicate the accident data within these segments (step 136). Accordingly, when the NMC 20 receives a request for a route that include a map segment with current accident data, the NMC 20 may includes a message to the requesting device (such as a TMCT, mobile navigation system 62, internet portal user 16, dispatcher at dispatch terminal 14, or traffic system 12) that an accident is present along the route. The NMC 20 may also suggest a route that does not include the map segments having the accident area.

FIG. 9 illustrates a flow diagram 140 for updating the RNTSD based on received fixed-location traffic data. As noted, some road systems have traffic measuring devices that measure the velocity of a vehicle at a particular location within the road network. The NMC 20 receives the fixed-location traffic data (step 142) and determines the map segments that include the fixed location (step 144). Then similar to flow diagram 80, the velocity information may be used to update the average velocity data for the corresponding map segments. In addition, this data may be time stamped and stored for archival purposes based on the map segments (step 146).

The RNTSD created and maintained by the NMC 20 via received data and flow diagrams may be used to determine future road project such as additional highway in the road network or additional lanes for existing roads. The RNTSD may also be used to plan an optimal route to one or more destinations. A TMCT, mobile navigation system 62, internet portal user 16, dispatcher at dispatch terminal 14, or traffic system 12 may generate a request for the optimal route on the road network from a location to a desired destination. For example, a driver may enter a vehicle and select a desired destination on a TMCT 32 or mobile navigation system 62, e.g., “office”, “sports stadium”, or “concert hall”. The TMCT 32 or system 62 may generate a route request that includes the vehicle's current location (position) and desired destination and transmit the request to the NMC 20.

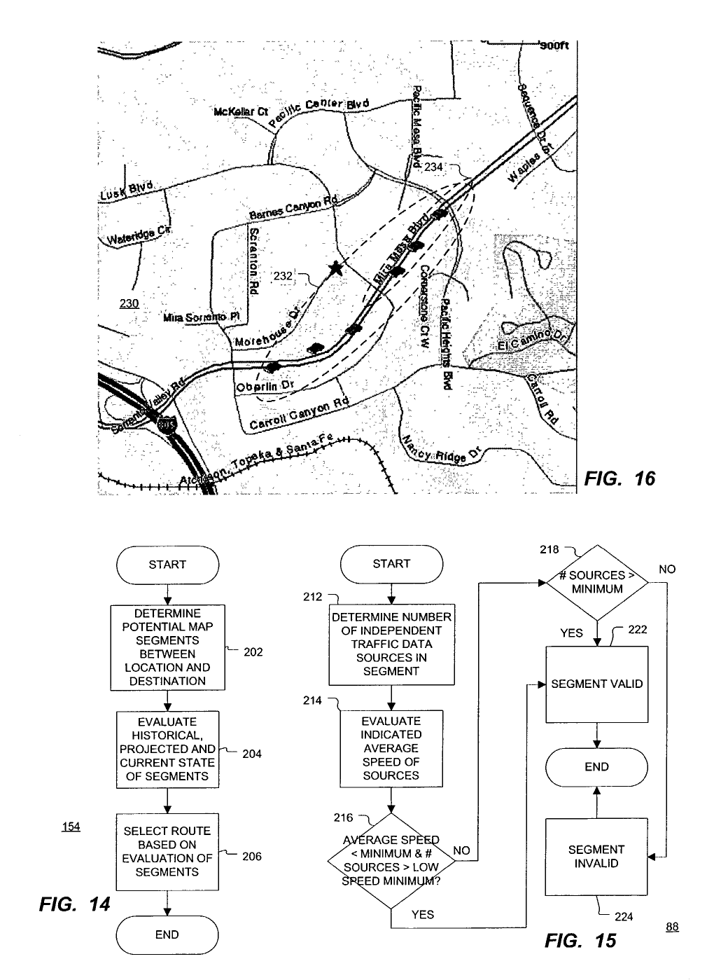

FIG. 10 illustrates a flow diagram 150 for determining an optimal road network route based on a starting location and proposed destination on the network. The NMC 20 receives the current or starting location and a desired destination (step 152). The NMC then determines the optimal route through the road network between the starting and ending location by evaluating the RNTSD (step 154). FIG. 14 illustrates a flow diagram 154 for determining an optimal route between the starting location and desired location based on map segments within the RNTSD. The NMC 20 determines potential map segments of the road network between the starting and desired ending location (step 202). The NMC 20 then evaluates different projected combinations of map segments that may form the route. The evaluation criteria may include real time data, past data for the same time of day, same time of day and day of week, and time of day, day of week, and calendar date. The evaluation criteria may also include projected changes to map segments such as projected construction that may occur while the vehicle propagates through a route in the road network (step 204). Other criteria may be selected such as shortest project time, shortest length (distance), most highways, most scenic, and others. The NMC 20 then selects the optimal route based on the evaluations (step 206) and transmits the optimal or best route to the requestor (step 156).

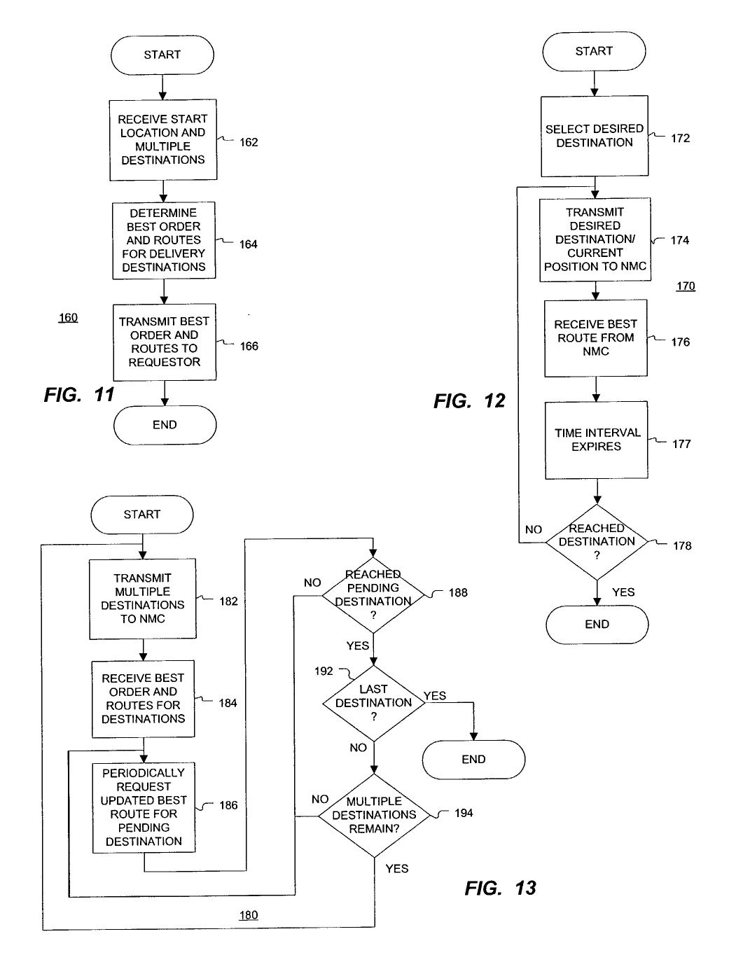

A requester may also desire the optimal route from a starting location to multiple locations or destinations. For example, a short range or long range delivery vehicle driver or dispatcher for the vehicle may request the optimal route for multiple destinations. Further, the order of the delivery may not be critical so the request may ask for the combination of the optimal order and route. FIG. 11 illustrates a flow diagram 160 for determining an optimal road network route between a starting location and several destinations within the road network. The NMC 20 receives the current or starting location and several desired destination (step 162) with or with order preference. The NMC then determines the optimal route through the road network between the starting and various destinations in different permutations by evaluating the RNTSD (step 154) for each permutation. Similar to algorithm 150, the NMC 20 evaluates different projected combinations of map segments that may form the route for each permutation. The evaluation criteria may include real time data, past data for the same time of day, same time of day and day of week, and time of day, day of week, and calendar date. The evaluation criteria may also include projected changes to map segments such as projected construction that may occur while the vehicle propagates through the route in the road network for each destination based on the order of the current permutation being evaluated. The NMC 20 then selects the optimal route based on the evaluations of each permutation (step 164) and transmits the optimal or best route to the requestor (step 166).

When a TMCT 32 or mobile navigation system 62 requests an optimal route for a starting location and desired destination, the TMCT 32 or system 62 may generate new requests as traveling to the destination. FIG. 12 illustrates a flow diagram 170 for requesting and receiving an evolving optimal road network route based on a desired destination and changing current location as the vehicle moves towards the destination. The desired destination is selected (step 172) and this destination and current location are transmitted to the NMC 20 (step 174). The NMC 20 generates the optimal route for the current location and destination and the optimal route is received (step 176). Then after a time interval (where the vehicle may travel closer, farther, or remain stationery) (step 177), the process (steps 174, 176, 177) are repeated until the vehicle reaches the destination (step 178). In this manner, the vehicle may be appraised of changes in the road network that make the current optimal route less optimal.

Similarly, a vehicle traveling to multiple destinations (e.g., multiple stops on a delivery route) may want to keep appraised of changes in the road network that may alter the optimal route and, perhaps the order of the remaining destinations. FIG. 13 illustrates a flow diagram 180 for requesting and receiving an evolving optimal road network route based on multiple desired destinations and changing current location as the vehicle moves from destination to destination. The desired destinations are selected and transmitted to the NMC 20 (step 182). The NMC 20 generates the optimal route between the current location and destinations and the optimal route is received (step 184). Then periodically determine whether route between current location and pending destination is optimal (steps 186 and 188). Then after reaching a destination and when multiple destinations (stops) remain, the algorithm 180 generates a new optimal route request with the remaining destinations (steps 194 and 182). This continues until all destinations have been reached (step 192).

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

We claim:

1. A system for determining optimal routes on a road network, comprising:
a network management center coupled to a wireless network and operable to receive data communications including data indicating vehicle positions and speeds and operable to receive a data communication indicating a request for an optimal route between a first location and a second location; a plurality of units within vehicles traveling on the road network and coupled to the wireless network and operable to transmit data to the network management center indicating the vehicle position and speed within the road network; and
a requesting unit coupled to the network management center and operable to generate a data communication requesting an optimal route between a first location and a second location.

2. The system of claim 1, wherein the network management center includes a memory for storing the vehicle positions and speeds.

3. The system of claim 1, wherein the network management center includes a processor for correlating a plurality of vehicle positions and speeds to determine an average speed.

4. The system of claim 3, wherein the processor determines the optimal route between the first location and second location based on the correlated vehicle speeds.

5. The system of claim 1, wherein the requesting unit is coupled to the wireless network.

6. The system of claim 5, wherein the requesting unit is located with a vehicle on the road network.

7. The system of claim 6, wherein the requesting unit periodically transmits its vehicle position and speed to the network management center.

8. The system of claim 1, wherein the network management center stores the time and date along with the vehicle position and speed in the memory.

9. The system of claim 1, wherein the processor determines an average vehicle speed within a segment of the road network by determining which received vehicle positions and speed data are within the segment and averaging only those speeds.

10. The system of claim 8, wherein the processor determines an average vehicle speed within a segment of the road network by determining which received vehicle positions and speed data are within the segment and have been received with a predefined time limit and averaging only those speeds.

11. A method of determining optimal routes on a road network, comprising the steps of:
receiving data communications including data indicating vehicle positions and speeds from a plurality of units within vehicles traveling on the road network from a wireless network;
receiving a data communication indicating a request for an optimal route between a first location and a second location from a requesting unit;
determining an optimal route between the first location and the second location based on the received vehicle positions and speeds; and
transmitting the optimal route to the requesting unit.

12. The method of claim 11, further comprising the step of storing the received vehicle positions and speeds.

13. The method of claim 11, further comprising the step of correlating a plurality of vehicle positions and speeds to determine an average speed.

14. The method of claim 13, wherein step c) includes determining the optimal route between the first location and second location based on the correlated vehicle speeds.

15. The method of claim 11, wherein the requesting unit is coupled to the wireless network.

16. The method of claim 15, wherein the requesting unit is located with a vehicle on the road network.

17. The method of claim 16, further comprising the step of periodically receiving the vehicle position and speed of the requesting unit.

18. The method of claim 17, further comprising the step of storing the vehicle position and speeds along the time and date they are received in a memory.

19. The method of claim 11, further comprising the step of determining an average vehicle speed within a segment of the road network by determining which received vehicle positions and speed data are within the segment and averaging only those speeds.

20. The system of claim 18, further comprising the step of determining an average vehicle speed within a segment of the road network by determining which received vehicle positions and speed data are within the segment and have been received with a predefined time limit and averaging only those speeds.
